(19) United States
(12) Patent Application Publication
(10) Pub. No.: US 2007/0252465 A1
(43) Pub. Date: Nov. 1, 2007

(54) Outer-rotor-type magneto generator

(75) Inventors: Kazuya Sasaki, Numazu-shi (JP); Reiji Sato, Numazu-shi (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Numazu-shi (JP)

(21) Appl. No.: 11/789,822

(22) Filed: Apr. 26, 2007

(30) Foreign Application Priority Data
Apr. 27, 2006 (JP) 2006-123067

(51) Int. Cl. H02K 7/00; H02K 21/12

(52) U.S. Cl. 310/156.26; 310/67 R; 310/261

(57) ABSTRACT

An outer-rotor-type magneto generator comprising: a magnet rotor having a cup-shaped rotor yoke and permanent magnets bonded to an inner surface of a periphery wall portion of the rotor yoke; and a stator having an armature core and armature coils wound around salient pole portions of the armature core, wherein a plurality of protrusions and recesses are arranged alternatively in a peripheral direction on an inner periphery of the peripheral wall portion of the rotor yoke, and the permanent magnets are bonded on stator sides of each protrusions.

### TECHNICAL FIELD OF THE INVENTION

The present invention relates to an outer-rotor-type magneto generator.

### BACKGROUND OF THE INVENTION

An outer-rotor-type magneto generator comprises a magnet rotor 3 and a stator 6 as shown in FIG. 5. The shown magnet rotor 3 is comprised of a cup-shaped rotor yoke 1 being consisted of ferromagnetic materials such as iron, and a plurality of permanent magnets 2 being intermittently arranged in a peripheral direction of a peripheral wall portion 1a of the rotor yoke and bonded to an inner surface of the peripheral wall portion 1a. The stator 6 is comprised of an armature core 4 having salient pole portions 4b radially protruded from an annular stator yoke 4a, and armature coils 5 wound around salient pole portion 4b of the armature core 4. On a tip of each salient pole portion of the armature core 4, there is formed a pole surface 4b1 opposed to poles of the magnet rotor 3.

In order to mount the magnet rotor 3 on a prime mover such as an engine, a boss portion 1b is provided at a center of a bottom wall portion of the rotor yoke 1, and a rotational shaft (not shown) of the prime mover is fitted with the boss portion 1b to fix the boss portion 1b with respect to the rotational shaft using suitable means.

The stator 6 is arranged inside of the magnet rotor 3, the annular stator yoke 4a of the armature core 4 is fixed to a case of the prime mover or the like, and the pole surface 4b1 on the tip of the salient pole portion 4b of the armature core 4 is opposed to the pole of the magnet rotor 3 with a predetermined air gap.

A ferrite magnet has been used as the permanent magnet 2; however, recently, a rare earth magnet having large magnetomotive force is often used in order to obtain a large output without making a generator large. A magneto generator which uses a rare earth magnet as a permanent magnet is shown in, for example, Japanese Patent Application Laid-open Application No. 2003-9441.

As shown in FIG. 5, since a magnet attachment surface (an inner peripheral surface of the peripheral wall portion 1a) ms′ of the rotor yoke 1 is consisted by an uniform curved surface (a cylindrical surface) along a peripheral direction in a conventional magneto generator, it was unavoidable that a clearance c′ between the magnet attachment surface ms′ and the pole surface 4b1 of the armature core becomes small. When the clearance c′ is small, a mass of pass through flux φ′, which is magnetic flux passing from the pole surface 4b1 of the armature core 4 to the rotor yoke side through an air gap between the pole surface 4b1 and the peripheral wall portion 1a of the rotor yoke when the armature reaction occurs, is caused. Thus, eddy-current loss which occurs at the peripheral wall portion of the rotor yoke becomes large because of the pass through flux φ′, which causes a problem that efficiency of the generator is lowered.

Also, when the eddy-current loss causes an increase in temperature of the rotor yoke and an increase in temperature of the magnet. Since the magnet has a characteristic that magnetic flux density is lowered along with an increase of temperature, the magnet having high magnetic flux density cannot be used when the temperature of the rotor yoke increases, and thus the temperature of the magnet increases. Therefore, use of a large magnet is necessary in order to increase the output of the generator; thus, increase in cost of the generator was unavoidable.

Further, when the large magnet is used in order to increase the output of the generator, the surface area of the magnet becomes large, which easily causes high temperature demagnetization. Thus, there were problems that the magnet performance cannot be fully utilized and that the output of the generator cannot be increased enough although the size of the magnet increases.

Also, since the temperature of the armature coils of the stator arranged inside of the magneto rotor increases with increasing the temperature of the magneto rotor, there were problems that the armature current is limited and that the output of the generator is limited.

Furthermore, since the increase in temperature of the armature coils causes an increase of a resistance value of a coil conductor, problems arise that a copper loss in the armature coils increases and that the efficiency of the generator decreases.

Each problem described above becomes more notable in case of using a rare earth magnet which thickness is considerably smaller than that of ferrite magnet.

### SUMMARY OF THE INVENTION

An object of the present invention is to provide an outer-rotor-type magneto generator in which: eddy-current loss, which is generated in a rotor yoke by pass through flux passing through an air gap between a stator and the rotor yoke when an armature reaction occurs, can be controlled in order to improve a generation efficiency; and temperature of the rotor can be prevented from increasing to solve various problems which occur when the temperature of the rotor increases.

The present invention is applied to an outer-rotor-type magneto generator comprising: a magnet rotor having a cup-shaped rotor yoke and permanent magnets intermittently arranged in a peripheral direction of a peripheral wall portion of the rotor yoke and bonded to an inner peripheral surface of the periphery wall portion of the rotor yoke; and a stator having an armature core including a plurality of salient pole portions protruded from an annular stator yoke in a radial direction and armature coils wound around the salient pole portions of the armature core, in which, inside of the magnet rotor, a pole surface on a tip of each salient pole portion of the armature core is opposed to poles of the magnet rotor.

In the present invention, on the inner periphery of the peripheral wall portion of the rotor yoke, a plurality of protrusions and recesses are formed to be alternatively arranged in the peripheral direction, and each permanent magnet is bonded to a stator side surface of the protrusion.

As described above, when a plurality of protrusions and recesses are formed to be alternatively arranged in the peripheral direction on the inner periphery of the peripheral wall portion of the rotor yoke, and each permanent magnet is bonded to the stator side surface of the protraction, it is possible to form a portion, which clearance formed between the pole surface of the armature core and the rotor yoke is large, between adjacent permanent magnets. Therefore, a total amount of pass through flux passing through an air gap between the armature core and the peripheral wall portion of the rotor yoke when an armature reaction occurs can be reduced, and thus an eddy-current loss generated on the peripheral wall portion of the rotor yoke can be reduced.

Since an increase in temperature of the rotor is prevented by reducing the eddy-current loss generated in the rotor, permanent magnets can be used with high magnetic flux density, and smaller permanent magnets can be used to reduce the cost if a requirement for the generator are same as that of the conventional generator. Also, since a surface area of the magnet can be reduced by making the size of the magnet smaller, high temperature demagnetization can be difficult to occur, and the magnet performance can be fully utilized.

Further, since the temperature rise of the armature coils arranged inside of the rotor can be prevented by enabling the temperature of the rotor to be lower, it is possible to prevent the armature currents from being limited by the temperature increase of the armature coils.

Also, it is possible to prevent a resistance value of a coil conductor from increasing by temperature rise of the armature coils and prevent copper loss generated in the armature coils from increasing, which can improve the efficiency of the generator.

In a preferable embodiment of the invention, the protrusions and recesses, which numbers are equal to that of the permanent magnets, are formed to be alternatively arranged in the peripheral direction on the inner periphery of the peripheral wall portion of the rotor yoke, and the permanent magnet is bonded to the stator side surface of each protrusion.

With such construction, since the recesses exists among all permanent magnets, an amount of pass through flux flowing from the magnetic pole surface of the armature core to the peripheral wall portion of the rotor yoke through the air gap when the armature reaction occurs can be reduced among all permanent magnets, and the eddy-current loss is reduced, which improves the efficiency of the generator.

The present invention is useful especially when thin rare earth magnet is used as a permanent magnet.

### BRIEF DESCRIPTION OF THE DRAWINGS

The above and other objects and features of the invention will be apparent from the detailed description of the preferred embodiments of the invention, which is described and illustrated with reference to the accompanying drawings, in which;

FIG. 1 is a front view showing an embodiment of the present invention;

FIG. 2 is a front view showing an another embodiment of the present invention;

FIG. 3 is a front view showing the another embodiment of the present invention;

FIG. 4 is a front view showing a further embodiment of the present invention; and

FIG. 5 is a front view showing a construction of a conventional outer-rotor-type magneto generator.

### DETAILED DESCRIPTION OF THE PREFERRED EMBODIMENTS

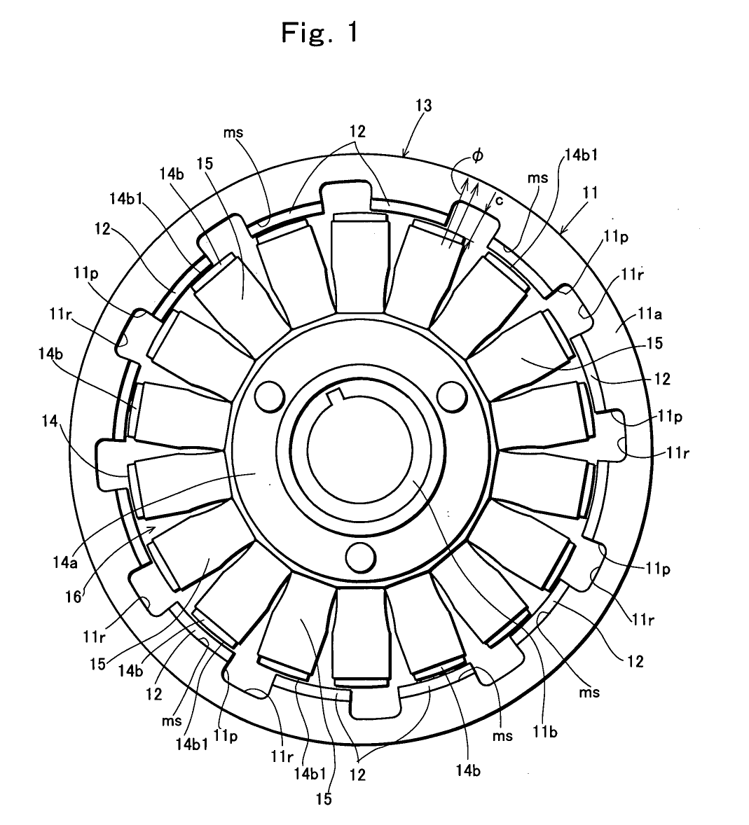

Now, preferred embodiments of the present invention will be described in detail with reference to FIG. 1. FIG. 1 shows one embodiment of the present invention, and in this drawing, a reference numeral 11 denotes a rotor yoke (flywheel) cup-shaped by ferromagnetic materials such as iron, 12 denotes a plurality (twelve in FIG. 1) of permanent magnets arranged intermittently in a peripheral direction of a periphery wall portion 11a of the rotor yoke 11 and bonded to an inner peripheral surface of the peripheral wall portion 11a.

In this embodiment, on an inner periphery of the peripheral wall portion 11a of the rotor yoke 11, there are formed protrusions 11p and recesses 11r, which numbers correspond to the number of the permanent magnets 12 being made of rare earth magnet, so as to be arranged alternatively in the peripheral direction. Each stator side surface of the protrusions 11p is considered as a magnet attachment surface ms having same arc length (length measured in the peripheral direction of the rotor) as the permanent magnets to be bonded, and each permanent magnet 12 is bonded by adhesive to the magnet attachment surface ms of each protrusions 11p. Each permanent magnet 12 is provided so as to be extruded from the protrusion 11p, and the recesses 11r are formed to be opened between adjacent permanent magnets 12, 12 . . . . The rotor yoke 11 and the permanent magnets 12 constitute an outer-rotor-type magnet rotor 13.

A reference numeral 14 denotes an armature core being consisted of a steel lamination layer. The armature core 14 is comprised of an annular stator yoke 14a and a plurality (eighteen in FIG. 1) of salient pole portions 14b protruded from an outer peripheral portion of the stator yoke 14a in the radial direction. An armature coil 15 is wound around each salient pole portion 14b of the armature core 14. The armature core 14 and the armature coils 15 constitute a stator 16. On a tip of each salient pole portion 14b of the armature core 14, there is formed a magnet pole surface 14b1 being opposed to magnet poles of the magnet rotor 13 through an air gap.

A boss portion 11b is provided at a center of a bottom wall portion of the cup-like rotor yoke 11. In order to mount the magnet rotor 13 on a prime mover such as an engine, a rotational shaft (not shown) of the prime mover is fitted with the boss portion 11b, and the boss portion 11b is fixed to the rotational shaft using suitable means.

The stator 16 is arranged inside of the magnet rotor 13 in a condition where a central axis of the stator 16 is consistent with that of the magnet rotor 13, and the annular stator yoke 14a of the armature core 14 is fixed to a case of the prime mover or the like. The magnet pole surface 14b1 on the tip of the salient pole portion 14b of the armature core 14 is opposed to the pole of the magnet rotor 13 with a predetermined air gap.

As described above, in the magneto generator according to the present invention, since the protrusions 11p and recesses 11r are arranged alternatively in the peripheral direction on the inner periphery of the peripheral wall portion of the rotor yoke 11, and the permanent magnets are bonded to the stator side surfaces of each protrusion 11p, the recesses 11r formed on the inner periphery of the rotor yoke is provided between the adjacent permanent magnets 12, 12, . . . . When the recesses 11r is thus provided, clearances C formed between the magnet pole surfaces of the armature core and the rotor yoke can be large at portions where the recesses 11r are formed. Therefore, it is possible to reduce a volume of pass through flux φ flowing, when occurring armature reaction, from the magnetic pole surfaces of the armature core 14 to the peripheral wall portion 11a of the rotor yoke though the air gap between the magnet pole surfaces of the armature core and the peripheral wall portion of the rotor yoke. Thus, reduction in eddy current loss which occurs at the peripheral wall portion 11a of the rotor yoke 11 and reduction in generator loss can be made.

In addition, temperature rise of the rotor can be prevented, and permanent magnets can be used with high magnetic flux density, since the eddy current loss generated in the rotor 13 can be reduced. Thus, the cost reduction can be accomplished by using smaller permanent magnets than conventional ones, in case where the requirement for the generator is the same as that for the conventional generator.

The surface area of the magnet can be small by downsizing the magnet furthermore, which makes it possible to prevent high temperature demagnetization from occurring. Therefore, performance of the magnet having high magnetic flux density can be fully utilized.

Further, since the reduction in temperature of the rotor 13 can prevent the temperature of the armature coil 15 arranged inside of the rotor from increasing, it is possible to prevent armature currents from being limited by the temperature rise of the armature coils 15. Also, it is possible to prevent a resistance value of a coil conductor from increasing by the temperature rise of the armature coils 15 and prevent copper loss generated in the armature coils from increasing, which can reduce the loss of the generator of the generator also.

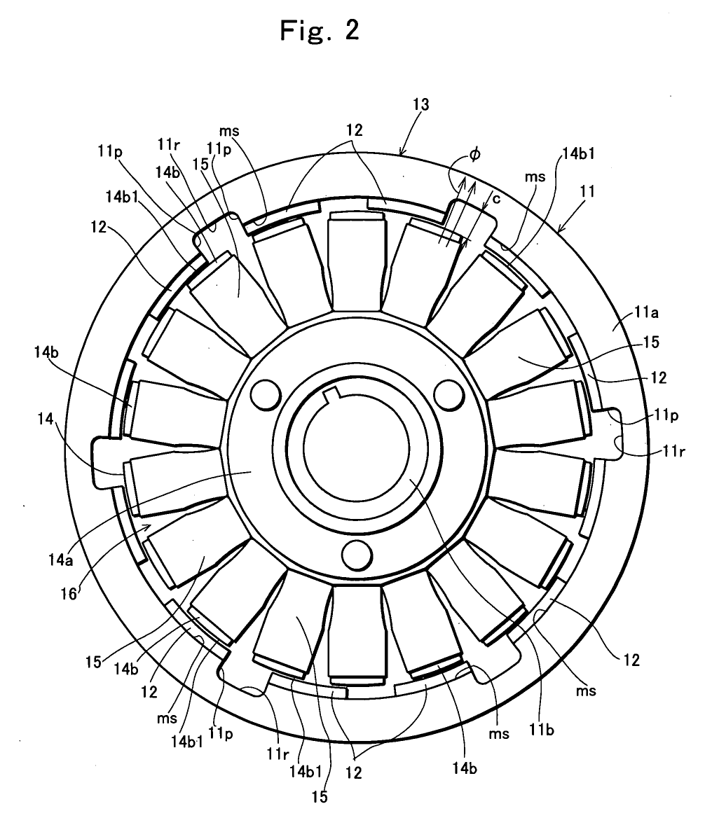

In the above-described preferable embodiment of the invention, the number of the protrusions 11p and recesses 11r being provided on the inner periphery of the rotor yoke is made equal to that of the permanent magnets, and one permanent magnet is bonded to each protrusion 11p. However, the present invention is not limited to such constructions. For example, as shown in FIG. 2, pole arc angle (central angle of an arc) of the protrusions 11p may become larger than that of the recesses 11r to bond two permanent magnets 12 to each protrusion 11p.

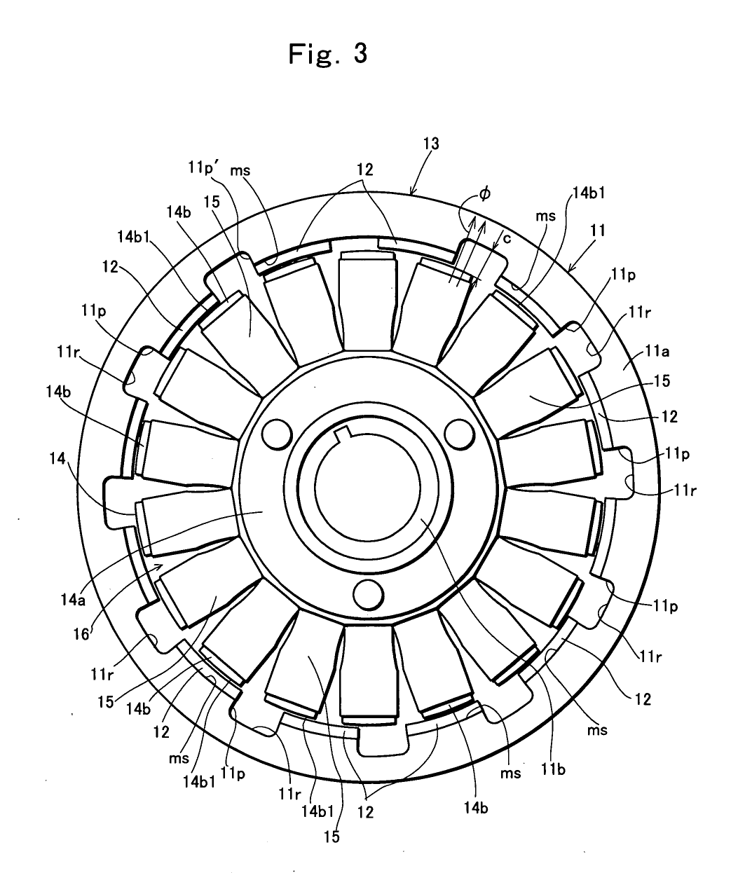

Also, pole arc angle of a part of protrusions may become larger than that of other protrusions to bond a plurality of permanent magnets to the protrusions having larger pole arc angle. For example, as shown in FIG. 3, pole arc angle of one protrusion 11p′ may be made larger than that of other protrusions 11p, two permanent magnets 12 may be bonded to the protrusion 11p′ having larger arc angle, and only one permanent magnet may be bonded to each of other protrusions.

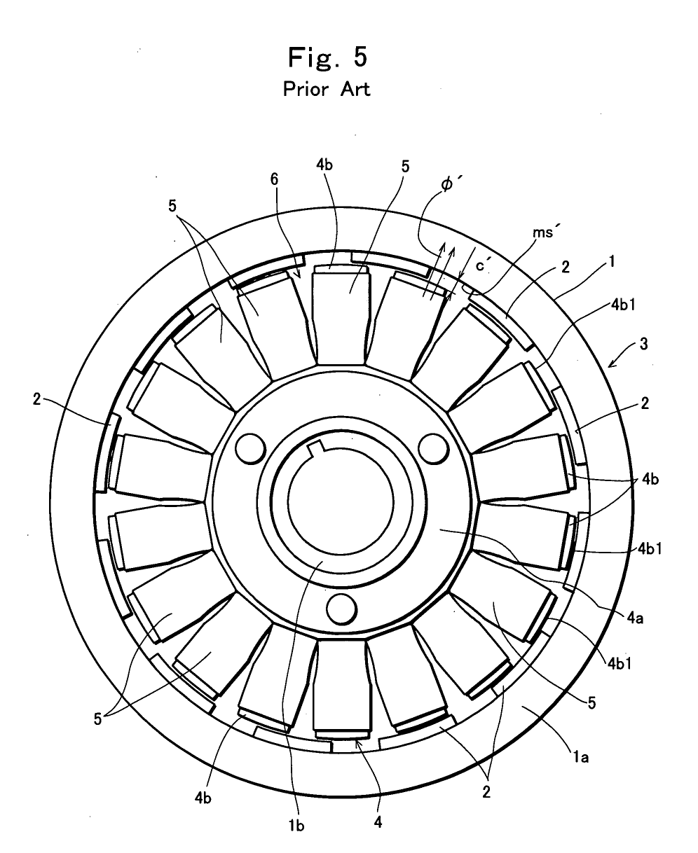

With such constructions shown in FIGS. 2 and 3, a total amount of pass through flux, which is generated by an armature reaction, passing from the armature core 14 to the peripheral wall portion 11a of the rotor yoke 11 through the air gap can be reduced as compared with a conventional construction in which the entire inner peripheral surface of the peripheral wall portion of the rotor yoke 1 is constituted so as to have uniform inner diameter as shown in FIG. 5, and thus the eddy current loss generated at the peripheral wall portion 11a of the rotor yoke 11 can be reduced to reduce the generator loss.

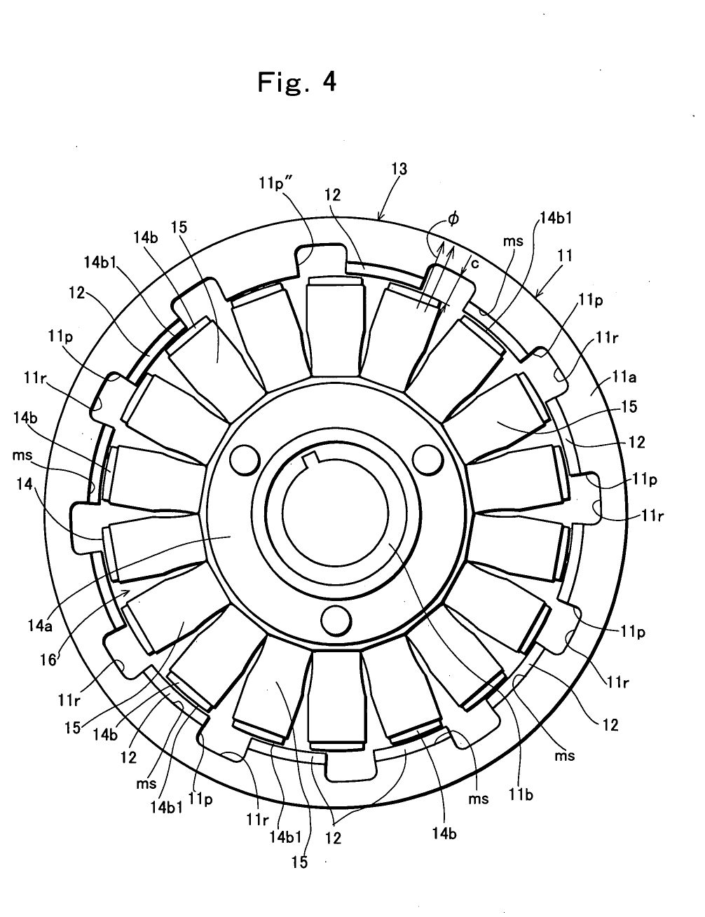

Also, in the above-described each embodiment, although the permanent magnets 12 are bonded to all protrusions formed on the inner periphery of the peripheral wall portion of the rotor yoke, the present invention can be applied to a case where a part of magnets, which are supposed to be arranged in the same angular intervals, is omitted in order to make it possible to detect a particular rotational angle position of the rotor by utilizing a distortion of a waveform of output voltage of the generator, or in order to limit the output of the generator for preventing the output of the generator from increasing too large excessively. For example, as shown in FIG. 4, no permanent magnet can be bonded to a stator side surface of a protrusion 11p″.

In the example shown in FIG. 4, protrusion length or height of the protrusion 11p″ is set so that a gap between the protrusion 11p″ having no permanent magnet and the magnet pole portion of the stator is the same in size as a gap between the magnet pole surfaces of the permanent magnets 12 and the magnet pole portion of the stator.

In the present invention, when a part of permanent magnets which are supposed to be arranged in the same angular intervals is omitted, it is not necessarily required to constitute as shown in FIG. 4, and the protrusion length or height of the protrusion 11p″ may be equal to protrusion length or height of other protrusions 11p.

As aforementioned, according to the present invention, since a plurality of protrusions and recesses are formed to be alternatively arranged in the peripheral direction on the inner periphery of the peripheral wall portion of the rotor yoke, and each permanent magnet is bonded to the stator side surface of the protrusion, it is possible to form a portion, which clearance formed between the magnet pole surface of the armature core and the rotor yoke is large, between adjacent permanent magnets. Therefore, it is possible to reduce a total amount of pass through flux passing from the magnet pole surface of the armature core to the peripheral wall portion side of the rotor yoke through the air gap when the armature reaction occurs, reduce the eddy-current loss generated at the peripheral wall portion of the rotor yoke, and thus increase the efficiency of the generator.

Also, according to the present invention, since an increase in temperature of the rotor by the eddy-current loss is prevented, the permanent magnets can be used with high magnetic flux density, and smaller permanent magnets can be used to reduce the cost if the requirement for the magnet generator is same as that for the conventional magneto generator.

Further, since surface areas of the magnets can be reduced by making the size of the magnets smaller, high temperature demagnetization can be difficult to occur, and thus the magnet performance can be fully utilized.

Furthermore, according to the invention, since the temperature rise of the armature coils arranged inside of the rotor can be prevented by enabling the temperature of the rotor to be lower, it is possible to downsize the generator without reducing generation outputs and easily manufacture the generator having desired functions at a low price, in cooperation with the reduction of loss, utilization of magnets with high magnetic flux density, and prevention of the high temperature demagnetization of the magnets.

Although some preferred embodiments of the invention have been described and illustrated with reference to the accompanying drawings, it will be understood by those skilled in the art that they are by way of examples, and that various changes and modifications may be made without departing from the spirit and scope of the invention, which is defined only to the appended claims.

What is claimed is:

1. An outer-rotor-type magneto generator comprising: a magneto rotor having a cup-shaped rotor yoke and permanent magnets intermittently arranged in a peripheral direction of a peripheral wall portion of the rotor yoke and bonded to an inner peripheral surface of the periphery wall portion of the rotor yoke; and a stator having an armature core including a plurality of salient pole portions protruded from an annular stator yoke in a radial direction and armature coils wound around the salient pole portions of the armature core, in which, inside of the magnet rotor, a pole surface on a tip of each salient pole portion of the armature core is opposed to poles of the magnet rotor,
wherein a plurality of protrusions and recesses are alternatively formed in the peripheral direction on the inner periphery of the peripheral wall portion of said rotor yoke, and
wherein said permanent magnet is bonded to a stator side surface of said protrusion.

2. An outer-rotor-type magneto generator comprising: a magneto rotor having a cup-shaped rotor yoke and permanent magnets intermittently arranged in a peripheral direction of a peripheral wall portion of the rotor yoke and bonded to an inner peripheral surface of the periphery wall portion of the rotor yoke; and a stator having an armature core including a plurality of salient pole portions protruded from an annular stator yoke in a radial direction and armature coils wound around the salient pole portions of the armature core, in which, inside of the magnet rotor, a pole surface on a tip of each salient pole portion of the armature core is opposed to poles of the magnet rotor,
wherein the same number of protrusions and recesses as said permanent magnet are alternatively formed in the peripheral direction on the inner periphery of the peripheral wall portion of said rotor yoke, and
wherein said permanent magnet is bonded to a stator side surface of said each protrusion.

3. The outer-rotor-type magneto generator according to claim 1, wherein each of said permanent magnets is comprised of rare earth magnet.

4. The outer-rotor-type magneto generator according to claim 2, wherein each of said permanent magnets is comprised of rare earth magnet.
